(19) United States
(12) Patent Application Publication
(10) Pub. No.: US 2013/0066800 A1
(43) Pub. Date: Mar. 14, 2013

(54) METHOD OF AGGREGATING CONSUMER REVIEWS

(71) Applicants: Scott Falcone, Frankfort, IL (US); Ed Garrison, Lake Bluff, IL (US)

(72) Inventors: Scott Falcone, Frankfort, IL (US); Ed Garrison, Lake Bluff, IL (US)

(21) Appl. No.: 13/230,791

(22) Filed: Sep. 12, 2011

(51) Int. Cl. G06Q 30/00; G06F 17/30

(52) U.S. Cl. 705/347; 707/723; 707/E17.001

(57) ABSTRACT

This invention is a computer-aided system, method, and product for creating, monitoring, and aggregating electronic consumer reviews of a specific entity. Moreover, the consumer reviews are automatically aggregated and grouped by the location of the consumer creating the review and the salesperson of the specific entity being reviewed. Each group of the grouped and aggregated consumer reviews are displayed on a network location that can be monitored by the entity being reviewed. Furthermore, each individual consumer review is displayed on at least two different network locations. Providing this plurality of network locations produces greater search engine optimization for the business being reviewed, and contributes to a higher search engine ranking on a plurality of search engine results pages.

### FIELD OF INVENTION

This invention generally relates to a method for aggregating and displaying consumer reviews for companies, products, salespeople, and services. Moreover, it pertains specifically to a computer-based system and method of aggregating the written reviews of past consumers under categories such as: the city in which the reviewer lives; the location of the business, if that business has more than one site; or by salesperson.

### BACKGROUND

Electronic consumer reviews and websites that compile such reviews are well known in the relevant art. Consumers can write and share electronic reviews relating to various companies, products, and services using a variety of systems and websites. A company that wishes to have its place of business, products, and/or services reviewed by the public can purchase space on a computer-based review website. These reviews and review forms can then be accessed by consumers who visit the review website, enabling the consumers to write new reviews or read previously posted reviews. For example, a consumer that has previously visited a restaurant that purchased space on the paid and limited review website can rate and review that restaurant on the review website. To do this, the consumer would go to the paid review website and search for the specific restaurant of interest. The consumer can then fill in the particular forms to write and submit a new review. The review is then stored in an electronic database and is accessible to other consumers who wish to read it. These other consumers may access any and all reviews by visiting the limited review website on their computers. When these information-seeking consumers visit the limited review website, they enter relevant search terms to pull up the appropriate information and/or webpage. The reviews are only specific to whatever search term has been entered by the consumers and may not necessarily be relevant for the consumers' needs. For example, the review found may be for a chain restaurant in the wrong location. The poorly organized reviews combined onto one general review website is the current state of the relevant art.

An alternative computer-based review website does not require the companies being reviewed to pay for, or otherwise sign up for, the service. These unlimited and free review websites function in a similar manner to the paid review websites, in that they allow consumers to write new reviews and read posted reviews. But, unlike the paid review sites, company review pages on the free review sites can be added by any consumer and need not be purchased by the company before reviews can be generated. This leaves the company being reviewed with even less control over the reviews submitted and the page that displays such reviews. Any consumer may add a new business to the unlimited review website and post reviews and/or pictures. This can lead to difficulties for the companies being reviewed, including duplicative webpages that do not combine all of the relevant reviews, thereby making the review site less effective for the businesses, services, or products reviewed. Or, even more troublesome for the companies being reviewed, false reviews or mistaken identities may occur.

For companies that use the Internet to obtain new business—which is just about every business these days—it is imperative that the company be highly ranked on search engine search result return pages. When a consumer is looking for a new product, a specific company, or is seeking to employ someone for a service, more and more frequently the consumer will turn to the Internet and enter a search term using a search engine. The results that are generated are ranked according to a ranking system established by the particular search engine used by the consumer. A company that is dependent upon potential consumer online searches to generate business will benefit by obtaining a higher ranking than its competitors on the search engine results page. Through Search Engine Optimization (SEO), a company can increase its rankings on such search engines. Keywords in the content of a company's site and links from other relevant and high-ranking sites are two ways that increase a company's ranking on the search engine results page. A company that only has one site may not obtain as high a ranking as desired, thereby losing out on exposure to clients and business opportunities.

There are significant problems of inefficiency with the current multi-company computer-based review sites. First, a generic computer-based review site may be filled with reviews for multiple businesses, from users from all over the world, or in regard to varying salespeople, specific to a particular company. The consumers who wish to view the previously posted reviews must sift through numerous potentially irrelevant reviews to find those that are most appropriate for their search. Consumers have come to expect efficient results when browsing for relevant information on the Internet and the fact that consumers have to sift through irrelevant reviews does not satisfy this expectation. Additionally, while the generic computer-based review sites themselves may obtain high rankings in a search engine results page, it does not necessarily follow that the businesses being reviewed are also highly ranked in the search engine results page.

Computer-based review sites that pertain to one specific type of business that exist in the prior art can somewhat minimize the need to sift through entirely irrelevant reviews. For example, the review site can limit itself to being a computer-based review website where consumers can write and review various car dealers. The consumer can go through a series of steps within the review website, narrowing his or her search by type of car manufacturer, followed by the state where the dealership is located. The consumer is then presented with a list of various car dealers for the type selected, which are present in the selected state. Selecting the name of a dealer connects the consumer to a page containing reviews and statistics for that specific dealer. While all the reviews are relevant to that specific dealer, the consumer must know about and find each specific dealer in his or her city by sifting through the list of irrelevant dealers within the selected state. Because there are multiple car dealers in any given city, and an exponential amount for any given state, the task of identifying all the relevant dealers is arduous. A better method would include a review site that automatically generated a list of reviews that were relevant to the consumer's more specific location. Furthermore, even when viewing the many reviews of a specific dealer, a consumer would find it helpful to access the reviews that pertain to the specific salesperson with whom he or she had met or referred. All of the currently available business specific review websites fail to do this, and there is no option to further narrow the consumer's search as such. Moreover, although the specific business type review websites are specific to a business type, the individual businesses themselves within that type are without control over the formatting of the review website. This prevents the business from benefiting from higher rankings on search engine results pages.

One solution for improving SEO results is the onerous task of creating a blog with off the shelf software, and manually copying each of that company's individual reviews from any and all websites onto the blog. The various reviews would need to be obtained from the companies' own websites and a multitude of other third party sources. Moreover, the blog would need to be constantly updated to remain relevant. If desired, the person transferring the reviews to the blog would manually sort the reviews within a plurality of relevant “categories” to make looking through the reviews more user friendly. This manual blog building process, however, would be very burdensome and costly.

Although there are numerous systems and methods currently available to help users obtain reviews about companies, none of these methods automatically aggregate the reviews to provide the consumers with an easy to use tool to find relevant reviews, and to aid the companies being reviewed in their SEO strategies.

Thus, there is a need in the art for a computer-based review website, system, and method that automatically aggregates relevant reviews onto an individual, first computer-based review website to enhance searches performed by consumers and enhance the SEO for companies that depend on such consumer searches.

### SUMMARY OF THE INVENTION

To minimize the limitations in the prior art, and to minimize other limitations that will become apparent upon reading and understanding the present specification, the present invention discloses a method and system for Web users to enter reviews of a specific business and aids in SEO for that specific business on the Internet. Moreover, it pertains specifically to a computer-aided system, method, and product that captures, and automatically aggregates the reviews in such a way so as to generate a high ranking on search engines.

One embodiment of the present invention is a computer-based method of aggregating consumer reviews comprising the steps of: providing an entity to be reviewed by a plurality of consumers of the entity; providing at least one host electronic data processing unit; wherein the at least one host electronic data processing unit is comprised of an electronic database; providing a plurality of secondary electronic data processing units; wherein the at least one host electronic data processing unit is networked with the plurality of secondary electronic data processing units; entering a plurality of consumer reviews of the entity by the plurality of consumers using the plurality of secondary electronic data processing units; uploading the plurality of consumer reviews to the electronic database; selecting by the entity one or more search terms to be associated with one or more common values; processing the plurality of uploaded consumer reviews by the at least one host electronic data processing unit to determine a presence of the one or more common values within an entirety of the plurality of uploaded consumer reviews; associating by the at least one host electronic data processing unit the one or more search terms with each common value of the one or more common values; wherein the one or more common values are subsets of one or more categories; aggregating the plurality of consumer reviews by the at least one host electronic data processing unit based on the one or more common values; grouping the aggregated plurality of consumer reviews based on at least one of the one or more common values; storing the grouped and aggregated plurality of consumer reviews in the electronic database; wherein the grouped and aggregated plurality of consumer reviews are accessible to the plurality of consumers as grouped and aggregated; retrieving at least one group of the grouped and aggregated plurality of consumer reviews from the electronic database; and displaying the retrieved at least one group of the grouped and aggregated plurality of consumer reviews. Preferably, the steps of the method also include associating each group of the grouped and aggregated plurality of consumer reviews with a network location. Preferably, each of the plurality of consumer reviews is aggregated and associated with at least two groups of the grouped and aggregated plurality of consumer reviews. The method may also include the steps of: moderating by the entity the plurality of consumer reviews before the plurality of consumer reviews are made accessible to the plurality of consumers. Preferably, the network location of each associated, grouped, and aggregated plurality of consumer reviews is optimized for a plurality of search engine rankings based on the step of associating by the at least one host electronic data processing unit the one or more search terms with each common value of the one or more common values. The method preferably also includes the steps of: generating by the at least one host electronic data processing unit a first electronic display; wherein the plurality of secondary electronic data processing units are comprised of one or more displays; displaying the first electronic display on the one or more displays of the plurality of secondary electronic data processing units; wherein the first electronic display is comprised of at least one consumer review of the plurality of consumer reviews and at least one electronic link to at least one of the plurality of network locations associated with the grouped and aggregated plurality of consumer reviews; and an electronic write a review link. The method may also include the steps of: generating by the at least one host electronic data processing unit a second electronic display; displaying the second electronic display on the one or more displays of the plurality of secondary electronic data processing units; wherein the second electronic display is comprised of all consumer reviews of at least one group of the grouped and aggregated plurality of consumer reviews from the electronic database, a plurality of electronic links to the plurality of network locations associated with the grouped and aggregated plurality of consumer reviews, and an electronic write a review link; selecting by a reviewing consumer the electronic write a review link; displaying on the one or more displays of the plurality of secondary electronic data processing units by the at least one host electronic data processing unit an electronic review form; wherein the electronic review form is comprised of a plurality of review data fields; wherein the plurality of review data fields are comprised of: a First Name data field; a Last Name data field; a Location data field; an E-Mail Address data field; a Rating data field; a Salesperson data field; and a Review data field; entering by the reviewing consumer a plurality of consumer review data into the plurality of review data fields to create a plurality of completed electronic review forms; wherein the plurality of consumer review data are the one or more common values; wherein the plurality of review data fields are the one or more categories; wherein the categories are comprised of a location category, and a salesperson category; wherein the location category is a location of the reviewing consumer, and the salesperson category is a salesperson of the entity being reviewed. Preferably, the step of moderating by the entity comprises the steps of: retrieving by the at least one host electronic data processing unit one of the plurality of completed electronic review forms; wherein the plurality of completed electronic review forms are comprised of: a Consumer Review data field; an Entity Response data field; and a drop down menu with at least an Approved option. The step of moderating by the entity further comprises the steps of: correcting by the entity a plurality of errors in the Consumer Review data field committed by the reviewing consumer to create a corrected consumer review data; entering by the entity a plurality of entity response data into the Entity Response data field; approving by the entity the corrected consumer review data and the entered entity response data, such that a plurality of moderated consumer reviews and entity responses are created; and uploading the plurality of moderated consumer reviews and entity responses to the electronic database.

In another embodiment, the electronic review form is comprised of a plurality of review data fields; wherein the plurality of review data fields are comprised of a location data field; wherein the location data field is a location of the reviewing consumer; and entering by the reviewing consumer the location of the reviewing consumer into the location data field to create a plurality of completed electronic review forms.

Another embodiment of the electronic review form is comprised of a plurality of review data fields; wherein the plurality of review data fields are comprised of: a location data field and a salesperson data field; wherein the location data field is a location of the reviewing consumer, and the salesperson data field is a salesperson of the entity being reviewed; and entering by the reviewing consumer the location of the reviewing consumer into the location data field and the name of the salesperson of the entity being reviewed into the salesperson data field.

Another embodiment of the invention is a computer-based method of aggregating consumer reviews comprising the steps of: providing an entity to be reviewed by a plurality of consumers of the entity; providing at least one host electronic data processing unit; wherein the at least one host electronic data processing unit is comprised of an electronic database; providing a plurality of secondary electronic data processing units; wherein the plurality of secondary electronic data processing units is comprised of a display; wherein the at least one host electronic data processing unit is networked with the plurality of secondary electronic data processing units; entering a plurality of consumer reviews of the entity by the plurality of consumers using the plurality of secondary electronic data processing units; uploading the plurality of consumer reviews to the electronic database; selecting by the entity one or more search terms to be associated with one or more common values; processing the plurality of uploaded consumer reviews by the at least one host electronic data processing unit to determine a presence of the one or more common values within an entirety of the plurality of uploaded consumer reviews; associating by the at least one host electronic data processing unit the one or more search terms with each common value of the one or more common values; wherein the one or more common values are subsets of one or more categories; aggregating the plurality of consumer reviews by the at least one host electronic data processing unit based on the one or more common values; grouping the aggregated plurality of consumer reviews based on at least one of the one or more common values; storing the grouped and aggregated plurality of consumer reviews in the electronic database; and wherein the grouped and aggregated plurality of consumer reviews are accessible to the plurality of consumers as grouped and aggregated. Preferably the steps of the method also include retrieving at least one group of the grouped and aggregated plurality of consumer reviews from the electronic database; generating by the at least one host electronic data processing unit an electronic display; displaying the electronic display on the one or more displays of the plurality of secondary electronic data processing units; and wherein the electronic display is comprised of all consumer reviews of the at least one group of the grouped and aggregated plurality of consumer reviews from the electronic data, a plurality of electronic links to a plurality of network locations associated with the grouped and aggregated plurality of consumer reviews, and an electronic write a review link. The method may also include the steps of: selecting by a reviewing consumer the electronic write a review link; displaying on the one or more displays of the plurality of secondary electronic data processing units by the at least one host electronic data processing unit an electronic review form; wherein the electronic review form is comprised of a plurality of review data fields; wherein the plurality of review data fields are comprised of a location data field; wherein the location data field is a location of the reviewing consumer; entering by reviewing consumer the location of the reviewing consumer into the location data field to create a plurality of completed electronic review forms; wherein the location of the reviewing consumer is one of the one or more common values; and wherein the location data field is one of the one or more categories. Preferably, the steps of the method also include associating each group of the grouped and aggregated plurality of consumer reviews with a network location; and wherein the network location of each associated, grouped, and aggregated plurality of consumer reviews is optimized for a plurality of search engine rankings based on the step of associating by the at least one host electronic data processing unit the one or more search terms with each common value of the one or more common values.

It is an object of the invention to overcome the limitations and shortcomings of the prior art by automatically aggregating electronic consumer reviews by salesperson and/or by location, with user-specified links to the aggregated pages and providing a specific unique network location for each business being reviewed. Rather than a general review site with various entities on one site, this invention provides more relevant reviews for the consumer, greater control over the consumer reviews by the business being reviewed, and the ability to obtain higher search engine rankings for the business.

Another object of the invention is to greatly enhance the search engine optimization of the site. This is done by proper placement of search terms that have been selected by the business being reviewed in the hypertext markup language (HTML code), which is served to the consumer, and by aggregating reviews in such a way as to influence search engines to rank highly the network locations for the aggregated term. Providing electronic links on each of the network locations that lead the consumer to specific network locations of grouped and aggregated reviews further increases the ranking of the business in various search engine rankings. Moreover, each review has its own network location, leading to even more network locations that are all associated with the business being reviewed and, once again, increasing the rankings for that business on a given search engine results page. For example, by grouping all reviews written by people in Naperville, Ill., together, and associating the groupings with specific hyperlinks, it influences search engines to list the site near the top of its rankings for “Naperville Ill.” and another term of the user's choosing, e.g. “Naperville Ill. [Brand Name of a Car] Dealer.” “[Brand Name of a Car] Dealer” would have been selected by the entity as a search term to be optimized. With multiple locations associated with [Brand Name of a Car]Dealer, the business will enjoy greater SEO and will appear higher on the search engine results page when consumers perform a search. Even if the specific dealership for [Brand Name of a Car]Dealer is not located in Naperville, Ill., because of the aggregation and grouping performed by the invention, the business that has selected such terms and acquired reviews from consumers in Naperville, Ill., will appear on highly ranked on the search engine results page. This provides a significant advantage for businesses that rely on the Internet to obtain customers.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps, which are illustrated. When the same numeral appears in different drawings, it refers to the same or like components or steps.

FIG. 1 is a screen shot of one embodiment of a display of an electronic data processing unit and shows the electronic review form to be completed by the reviewing consumer.

FIG. 2 is a screen shot of one embodiment of a display of an electronic data processing unit and shows a completed electronic review form.

FIG. 3 is a screen shot of one embodiment of a display of an electronic data processing unit and shows the completed moderating form.

FIG. 4 is a screen shot of one embodiment of a display of an electronic data processing unit and shows the first page of the main screen of an entity.

FIG. 5 is a screen shot of one embodiment of a display of an electronic data processing unit and shows a second page of the main screen shown in FIG. 4.

FIG. 6 is a screen shot of one embodiment of a display of an electronic data processing unit and shows a third page of the main screen shown in FIGS. 4-5.

FIG. 7 is a screen shot of one embodiment of a display of an electronic data processing unit and shows a fourth page of the electronic display main screen shown in FIGS. 4-6.

FIG. 8 is a screen shot of one embodiment of a display of an electronic data processing unit and shows a fifth page of the electronic display main screen shown in FIGS. 4-7.

FIG. 9 is a screen shot of one embodiment of a display of an electronic data processing unit and shows a first page of a location specific screen.

FIG. 10 is a screen shot of one embodiment of a display of an electronic data processing unit and shows a second page of a location specific screen shown in FIG. 9.

FIG. 11 is a screen shot of one embodiment of a display of an electronic data processing unit and shows a third page of a location specific screen shown in FIGS. 9-10.

FIG. 12 is a screen shot of one embodiment of a display of an electronic data processing unit and shows a fourth page of a location specific screen shown in FIGS. 9-11.

FIG. 13 is a screen shot of one embodiment of a display of an electronic data processing unit and shows a first page of the salesperson specific screen.

FIG. 14 is a screen shot of one embodiment of a display of an electronic data processing unit and shows a second page of the salesperson specific screen shown in FIG. 13.

FIG. 15 is a screen shot of one embodiment of a display of an electronic data processing unit and shows a third page of the salesperson specific screen shown in FIGS. 13-14.

FIG. 16 is a screen shot of one embodiment of a display of an electronic data processing unit and shows a fourth page of the salesperson specific screen shown in FIGS. 13-15.

FIG. 17 is a flow chart of one embodiment of the networked plurality of electronic data processing units.

FIG. 18 is a flowchart of one embodiment of the invention.

FIG. 19 is a flowchart of one embodiment of the invention and shows the aggregation process that is performed by the host electronic data processing unit.

FIG. 20 is a flowchart of one embodiment of the method of associating, grouping, aggregating, storing, moderating, and displaying consumer reviews.

### DETAILED DESCRIPTIONS OF THE DRAWINGS

In the following detailed description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “computer” or “electronic data processing unit” refers to any electronic data processing unit or device that processes information with an integrated circuit chip, including without limitation, mainframe computers, embedded computers, wireless devices including cellular phones, personal digital assistants, and portable game players, and hand-held computers. The term “internet” refers to any collection of networks using standard protocols, whether Ethernet, ATM, FDDI, WI-FI, Token ring, or any combination thereoDevice for storing data refers to RAM, flash drive, or other writable data structure that can receive data and write data to a data storage device. The term “network location” refers to any Internet server or IP Address, also known as the “host name” and “internet address,” and has a visible display in the form of a website, webpage, or other viewable document when connected to the Internet with a web browser.

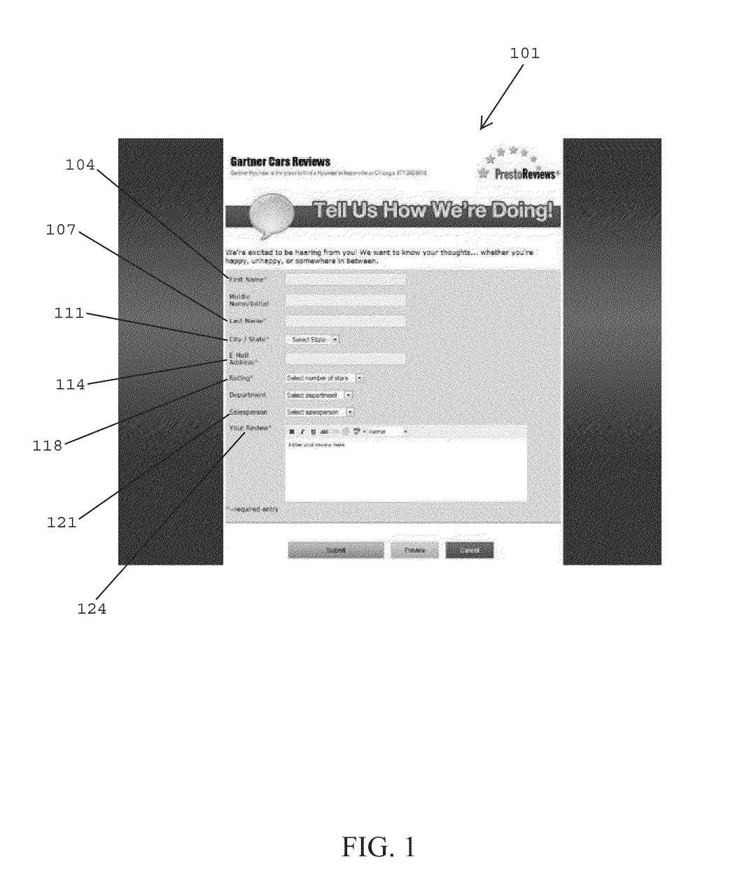

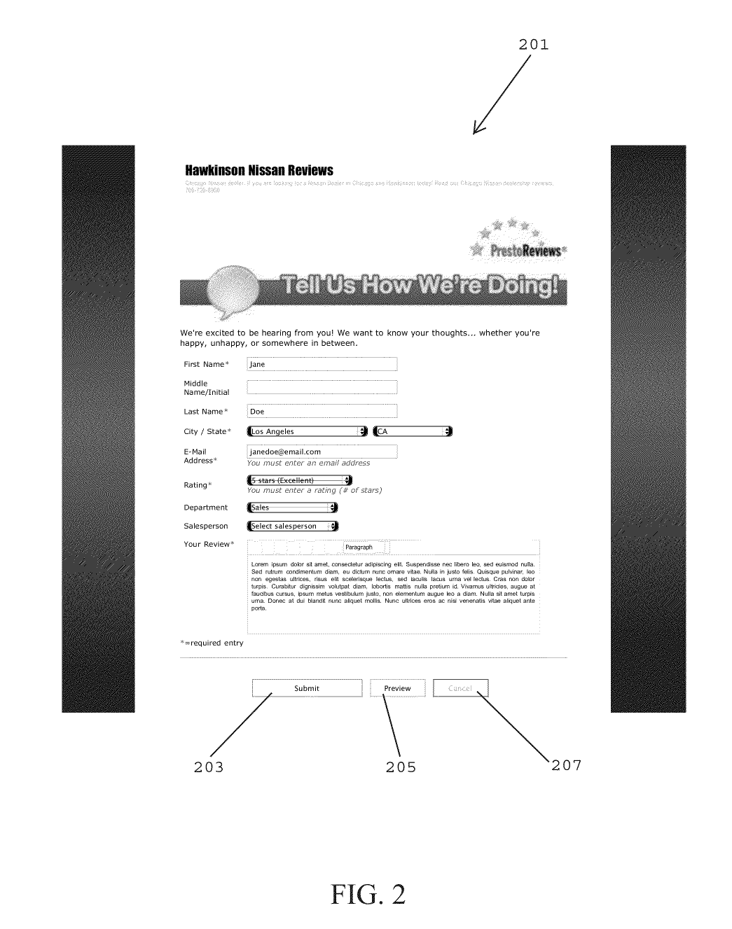

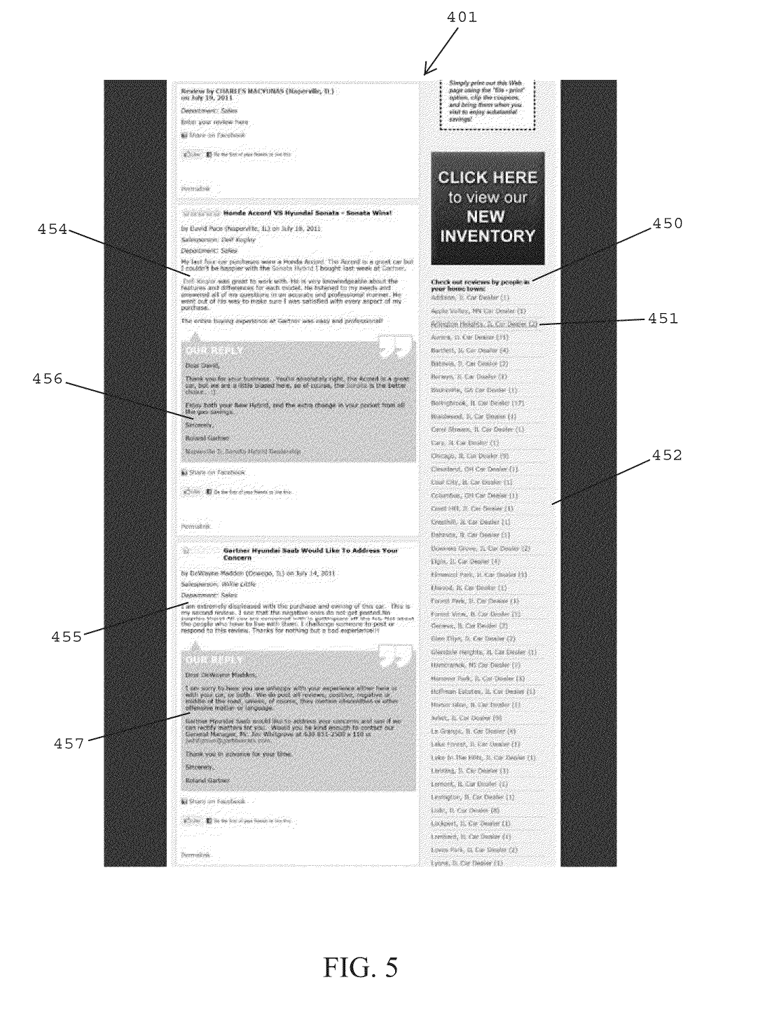

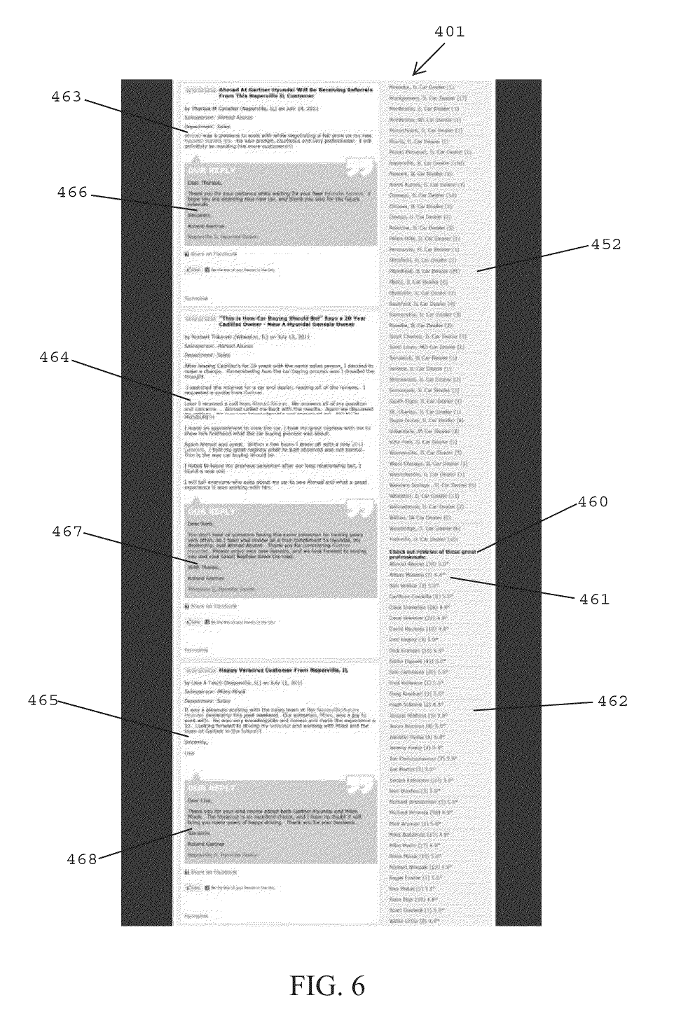

FIG. 1 is a screen shot of one embodiment of a display of an electronic data processing unit and shows the electronic review form to be completed by the reviewing consumer. As shown in FIG. 1, the electronic review form 101 is preferably comprised of a plurality of review data fields, including, but not limited to: a First Name 104 data field; a Last Name 107 data field; a City/State 111 data field; an E-Mail Address 114 data field; a Rating 118 data field; a Salesperson 121 data field; and a Your Review 124 data field. The reviewing consumer enters review data into some or all of the plurality of review data fields such that a completed form (as shown in FIG. 2) is created. The review data that is entered into the City/State 111 data field might later be used as a common value by the host electronic data processing unit to group and aggregate the created consumer review with other reviews that contain the same review data in the City/State 111 data field. These grouped and aggregated reviews will then be accessible to the consumer via a list of electronic links under a Location Category (as shown in FIG. 5). Similarly, the review data that is entered into the Salesperson 121 data field will be used as a common value by the host electronic data processing unit to group and aggregate the created consumer review with other reviews that have been written about the specified Salesperson. These grouped and aggregated reviews will then be accessible to the consumer via a list of electronic links under a Salesperson Category (as shown in FIG. 6) Importantly, any of the fields or review data entered into the fields may be grouped and aggregated.

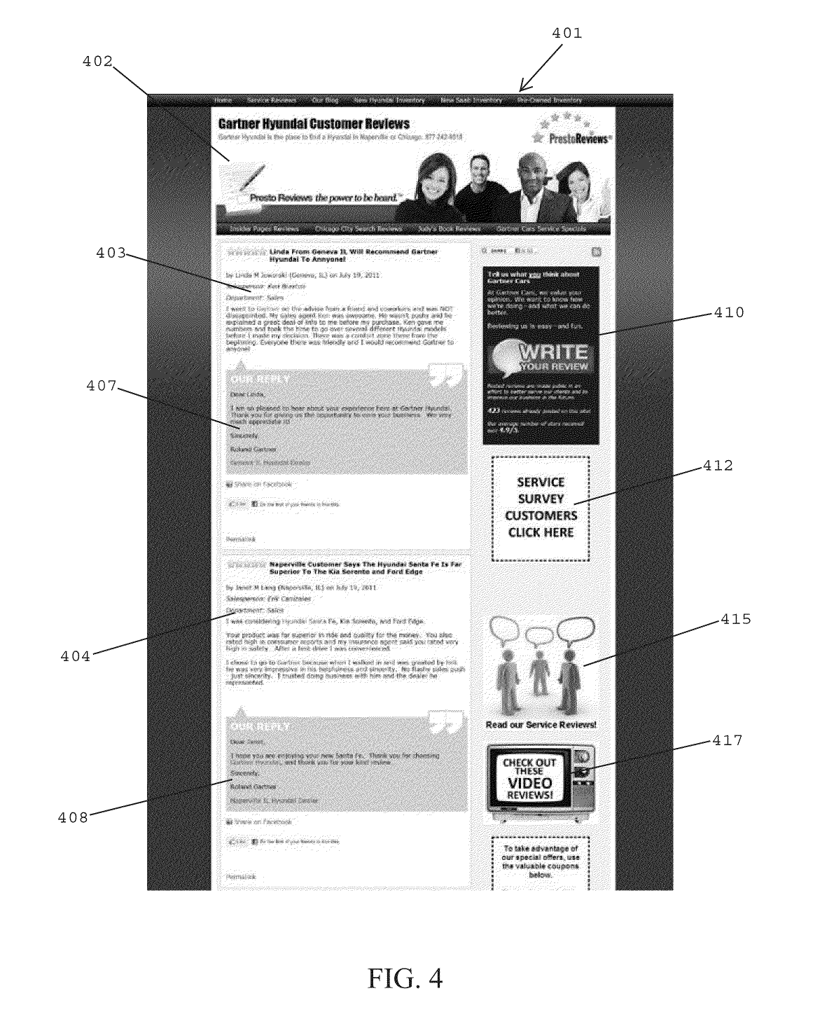

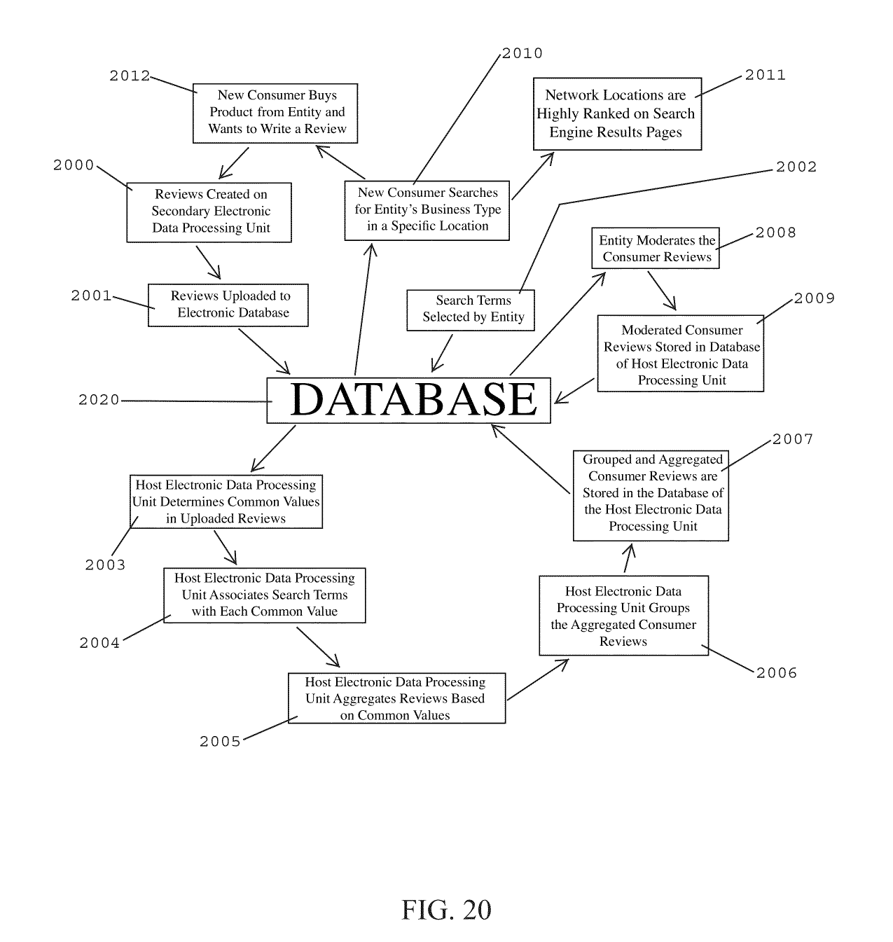

FIG. 2 is a screen shot of one embodiment of a display of an electronic data processing unit and shows a completed electronic review form. As shown in FIG. 2, the consumer has entered review data into each review data field of the plurality of review data fields on the completed electronic review form 201. Once the review data has been entered, creating the completed electronic review form 201, the reviewing consumer will typically select Submit 203, Preview 205, or Cancel 207. Selecting Submit 203 will submit the completed electronic review form so that it is uploaded to the electronic database (as shown in FIG. 20). Selecting Preview 205 will allow the reviewing consumer to see a preview of the review as it will eventually appear on the electronic display. Selecting Cancel 207 will delete the completed electronic review form and return the user to the electronic display main screen, as shown in FIG. 4.

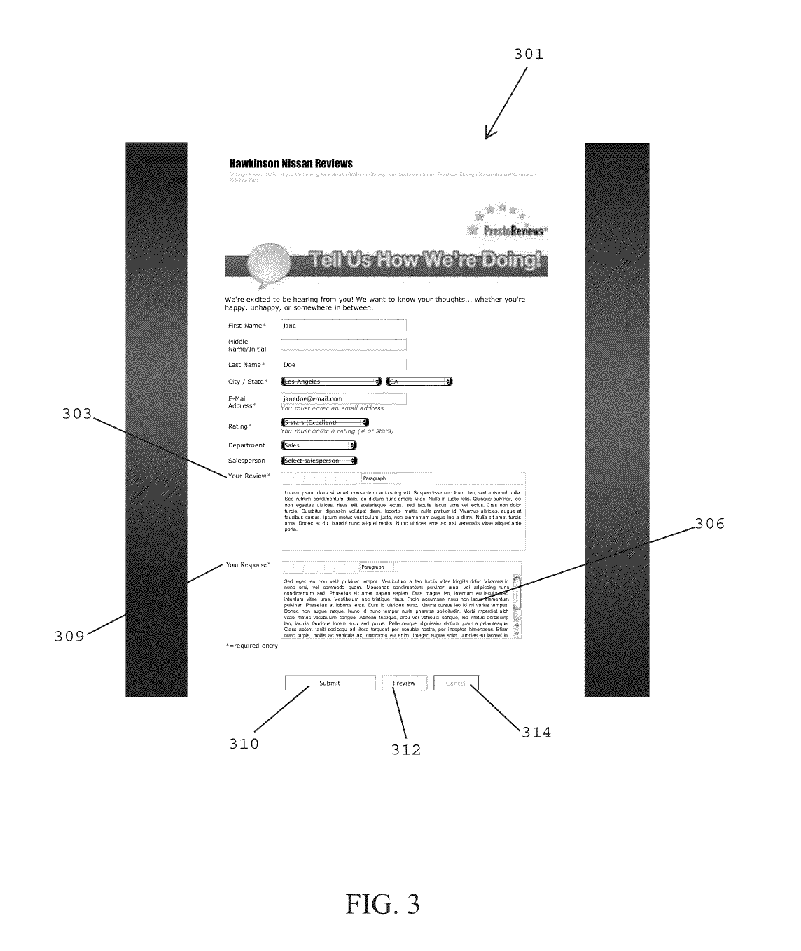

FIG. 3 is a screen shot of one embodiment of a display of an electronic data processing unit and shows the completed moderating form. As shown in FIG. 3, the Your Review 303 data field contains the review data as was entered by a reviewing consumer. The entity has the opportunity to correct any errors in the Your Review 303 data field that had been made by the reviewing consumer, such as grammatical and spelling errors. FIG. 3 shows that the entity may also correct any of the other review data fields, such as the reviewers name or location. The entity may enter entity response data 306 into the Your Response 309 data field. FIG. 3 shows the Your Response 309 data field after entity response data 306 has already been entered. This entity response data will appear under the respective consumer review, as shown in FIG. 4. Upon completing the moderating form 301, the entity will select either Submit 310, Preview 312, or Cancel 314. Selecting Submit 310 will submit the completed moderating form and upload it to the electronic database (as shown in FIG. 20). Selecting Preview 312 will allow the entity to preview the completed consumer review and accompanying entity response as it will appear on the electronic display. Selecting Cancel 314 will delete the completed moderating form and return the entity to the electronic display main screen, as shown in FIG. 4.

FIG. 4 is a screen shot of one embodiment of a display of an electronic data processing unit and shows the first page of the main screen of an entity. As shown in FIG. 4, the electronic display main screen 401 is preferably comprised of a leaderboard 402, consumer reviews 403 and 404, entity responses 407 and 408 to each of the consumer reviews 403 and 404, a write a review option 410, and various advertisements and other links 412, 415, and 417. The leaderboard 402 preferably displays the name of the specific entity being reviewed. Although FIG. 4 shows “Gartner Hyundai Customer Reviews,” “Gartner Hyundai” is intended to only be an example of the contents of the leaderboard 402, and will be changed to reflect the entity being reviewed on each specific network location. The consumer reviews 403 and 404 have been grouped and aggregated and are displayed in a column on the left hand side on the electronic display main screen 401. A reviewing consumer who wishes to add a new consumer review, will select the write a review option 410. Selecting this write a review option 410 will display the electronic review form shown in FIG. 1. After submission of the new consumer review, it will be grouped and aggregated (as shown in FIG. 20), and may be displayed on the electronic display main screen 401, along with the displayed consumer reviews 403 and 404. The various advertisements and other links 412, 415, and 417 shown in FIG. 4 are intended only to be representative of what could appear on the right hand side of the electronic display main screen 401. Each advertisement or other link 412, 415, and 417 may be different depending on the entity and the specific network location that displays the electronic display main screen 401.

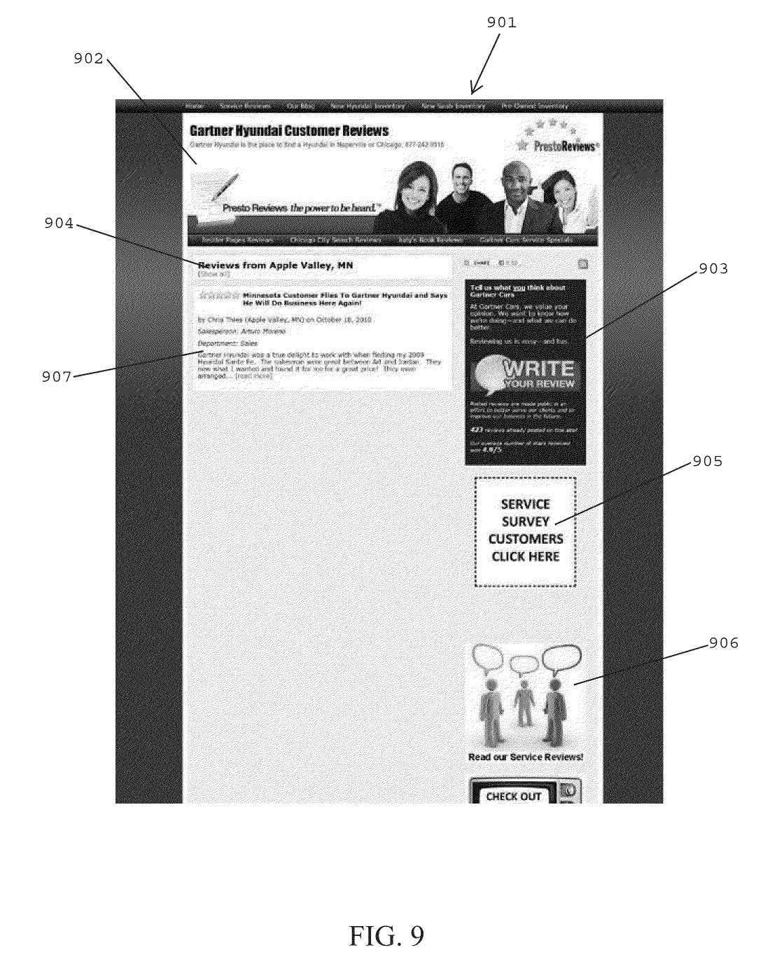

FIG. 5 is a screen shot of one embodiment of a display of an electronic data processing unit and shows a second page of the main screen shown in FIG. 4. FIG. 5 shows that the main screen might require the user to scroll down to see all of the reviews, including consumer reviews 454 and 455. FIG. 5 also shows further entity responses 456 and 457 to each respective consumer review 454 and 455. All of the reviews and responses are preferably displayed on the left hand side of the electronic display main screen 401. Additionally, there is a list of electronic links 452 under a Location Category 450. Each of the electronic links in the list of electronic links 452 identifies a link to a group of grouped and aggregated consumer reviews that have been completed by reviewing consumers within that city and state displayed on the face of the electronic link. Selecting one of the electronic links from the list of electronic links 452 displays an electronic display with reviews specific to the given location selected. For example, clicking on the “Apple Valley, Minn.” link 451 will display the electronic display location specific screen, as shown in FIG. 9, containing a group of grouped and aggregated reviews completed by reviewing consumers who live in Apple Valley, Minn.

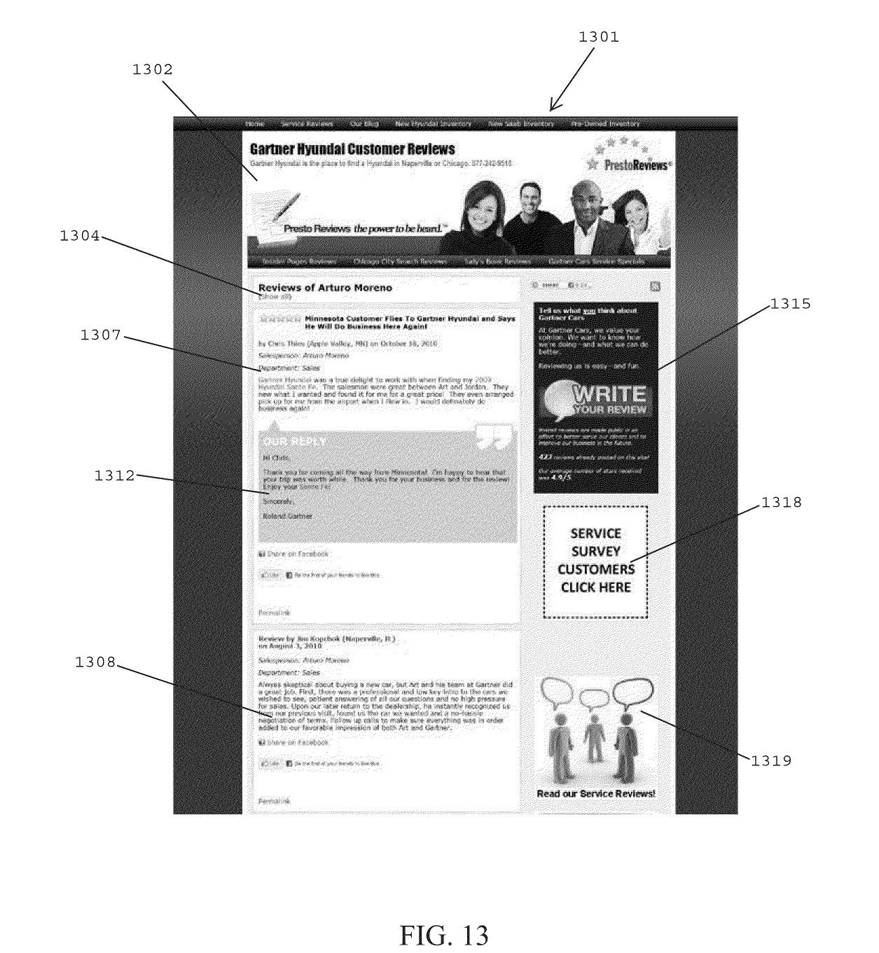

FIG. 6 is a screen shot of one embodiment of display of an electronic data processing unit and shows a third page of the main screen shown in FIGS. 4-5. FIG. 6 shows a continuation of additional consumer reviews 463, 464, and 465, with the entity responses 466, 467, and 468 to each respective consumer review 463, 464, and 465. The right hand side of the electronic display main screen 401 shows a continuation of the list of electronic links 452 under the Location Category shown in FIG. 5. Additionally, a second list of electronic links 462 is displayed under a Salesperson Category 460. Each of the electronic links in the second list of electronic links 462 identifies a link to a group of grouped and aggregated reviews written about the designated salesperson whose name is displayed in the electronic link. Selecting one of the electronic links from the second list of electronic links 462 will display an electronic display with reviews specific to the given salesperson selected. For example, selecting the “Arturo Moreno” link 461 will display the electronic display salesperson specific screen, as shown in FIG. 13, containing a group of grouped and aggregated reviews written about salesperson, Arturo Moreno.

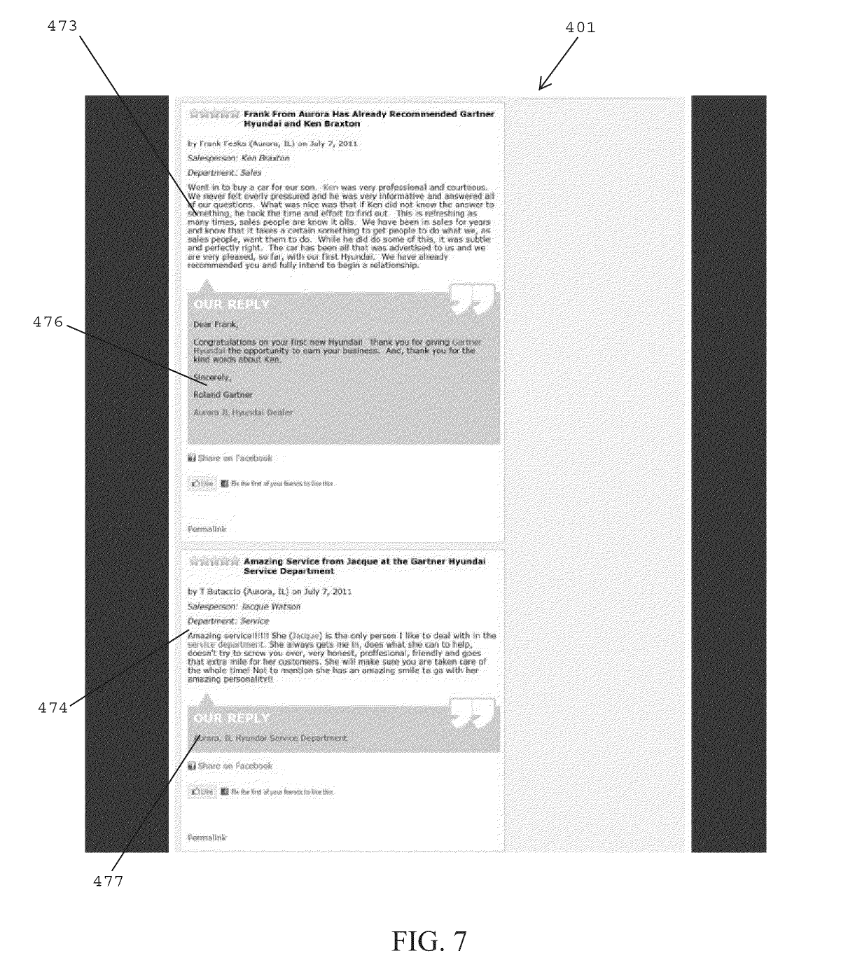

FIG. 7 is a screen shot of one embodiment of a display of an electronic data processing unit and shows a fourth page of the electronic display main screen shown in FIGS. 4-6. FIG. 7 shows a continuation of additional consumer reviews 473 and 474 specific to the given entity, with entity responses 476 and 477 to each respective consumer review 473 and 474.

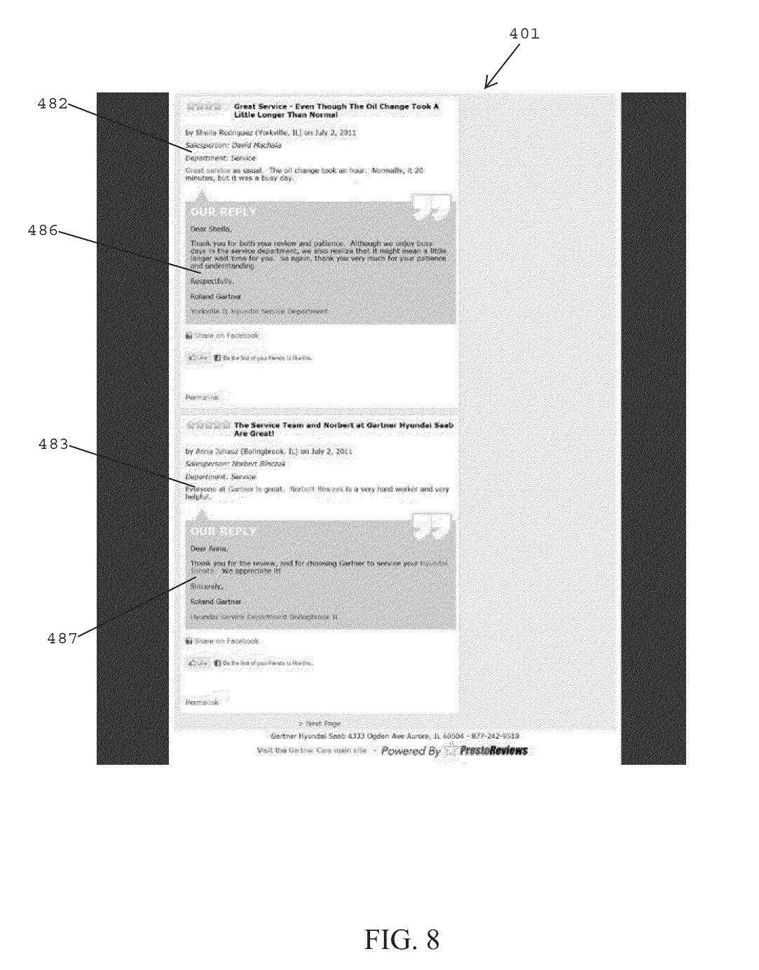

FIG. 8 is a screen shot of one embodiment of a display of an electronic data processing unit and shows a fifth page of the electronic display main screen shown in FIGS. 4-7. FIG. 8 shows a continuation of additional consumer reviews 482 and 483 specific to the given entity, with entity responses 486 and 487 to each respective consumer review 482 and 483.

FIG. 9 is a screen shot of one embodiment of a display of an electronic data processing unit and shows a first page of a location specific screen. The electronic display location specific screen 901 is preferably comprised of a leaderboard 902, a title 904, at least one consumer review 907, a write a review option 903, and various advertisements and other links 905 and 906. The leaderboard 902 preferably displays the name of the specific entity being reviewed. Although FIG. 9 shows “Gartner Hyundai Customer Reviews,” “Gartner Hyundai” is intended only to be an example of the contents of the leaderboard 902, and will be changed to reflect whichever entity is specifically being reviewed and displayed at the given network location. The title 904 on the electronic display location specific screen 901 reflects the city and state in which the consumers who have written the consumer reviews 907 live, and the specific group of grouped and aggregated consumer reviews 907 that are displayed on the electronic display location specific screen 901. For example, in FIG. 9, the consumer review 907 is a consumer review that was written by a consumer who lives in Apple Valley, Minn. Therefore, the title 904 shows “Reviews from Apple Valley, Minn.” This electronic display location specific screen 901 is generated and displayed when a consumer selects the “Apple Valley” electronic link in the list of electronic links under the Location Category, as shown on the electronic display main screen in FIG. 5. By aggregating all of the reviews written by consumers by location, consumers can find more useful reviews of the entity. Selecting the write a review option 903 will display the electronic review form shown in FIG. 1, which can then be completed by the reviewing consumer. After submission of the new consumer review, it will be grouped and aggregated (as shown in FIG. 20). If the consumer lives in Apple Valley, Minn., this additional review would then later be displayed on the electronic display location specific screen 901, along with the displayed consumer review 907. Various advertisements and other links 905 and 906 are displayed along the right hand side of the electronic display location specific screen 901. The various advertisements and other links 905 and 906 shown in FIG. 9 are intended to be representative of possible advertisements that may be displayed. Each advertisement or link may be different depending upon the specific network location of each entity being reviewed and each location in which the reviewing consumers live.

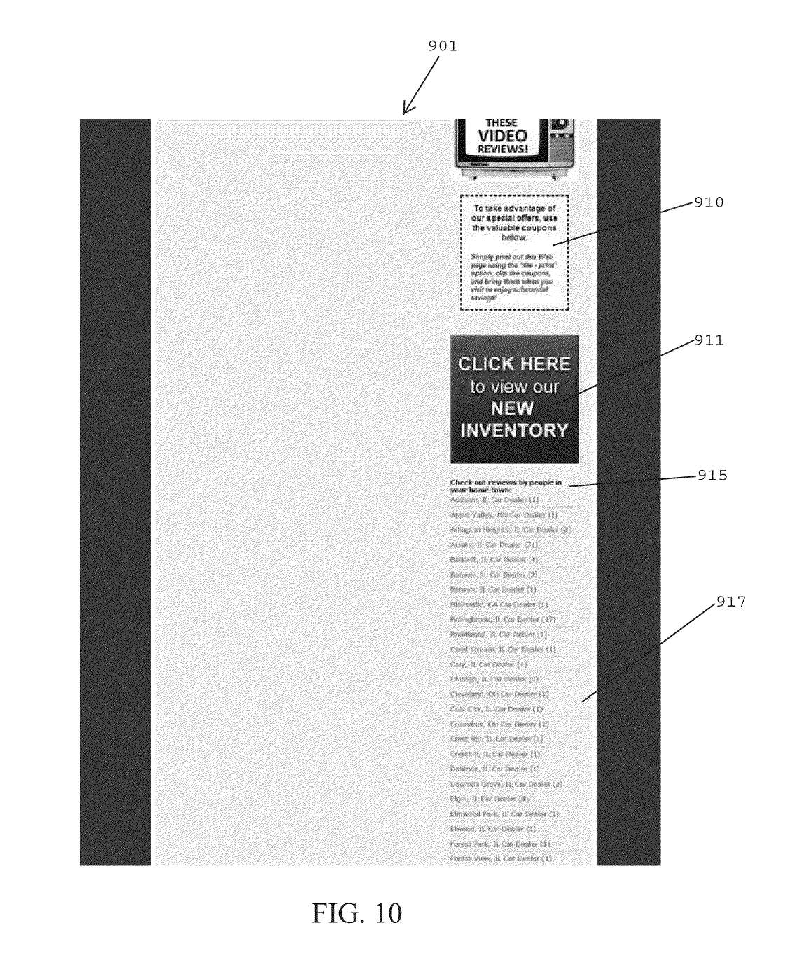

FIG. 10 is a screen shot of one embodiment of a display of an electronic data processing unit and shows a second page of a location specific screen shown in FIG. 9. A continuation of various advertisements and other links 910 and 911, and a list of electronic links 917 under the Location Category 915 are displayed on the continuation of the electronic display specific location screen 901. Similar to FIG. 9, the various advertisements and other links 910 and 911 are intended to be representative of possible advertisements and other links that may be displayed, and may be different depending upon the specific network location of each entity being reviewed and each location in which the reviewing consumers live. The list of electronic links 917 is preferably identical to the list of electronic links shown in FIG. 5. This is because the same entity is being reviewed in FIG. 10 as is being reviewed in FIG. 5, and the list of electronic links 917 is generated for a given entity being reviewed regardless of whether the list of electronic links 917 is displayed on the electronic display main screen shown in FIG. 5, or the electronic display location specific screen 901 shown in FIG. 10. Although the grouped and aggregated reviews that are displayed on the electronic display location specific screen 901 are specific to a given location, the list of electronic links 917 remains the same for all electronic displays generated and displayed for a given entity. Selecting one of the electronic links in the list of electronic links 917 displays a new network location with a group of grouped and aggregated consumer reviews specific to the location selected.

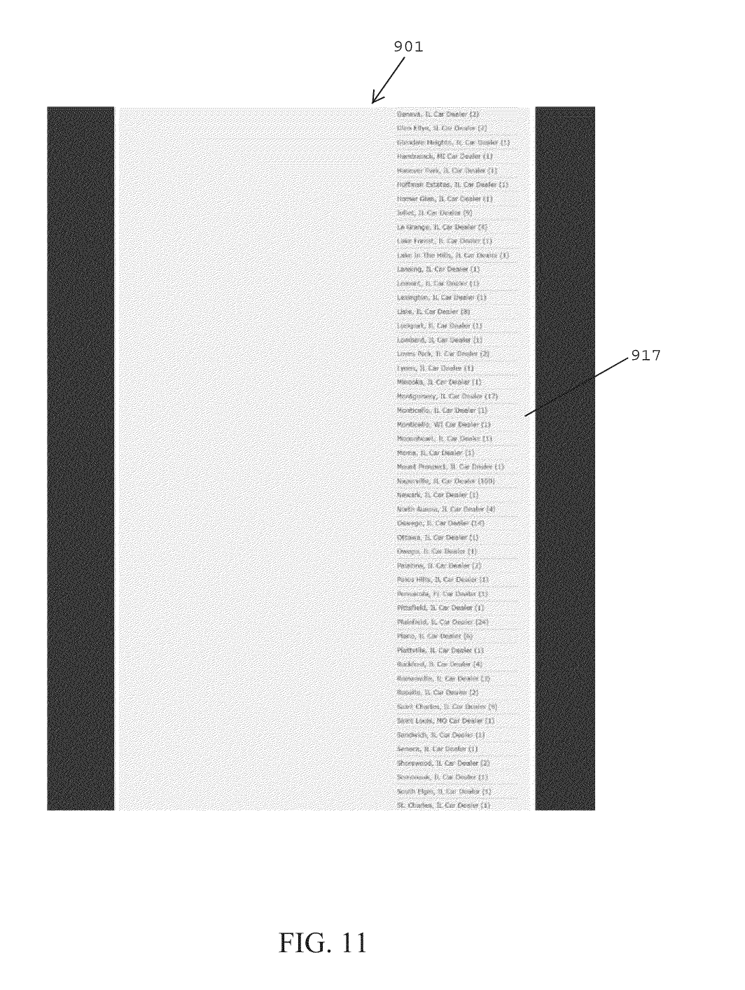

FIG. 11 is a screen shot of one embodiment of a display of an electronic data processing unit and shows a third page of a location specific screen shown in FIGS. 9-10. FIG. 11 shows a continuation of the list of electronic links 917 under the Location Category as shown in FIG. 10, is displayed on a continuation of the electronic display location specific screen 901.

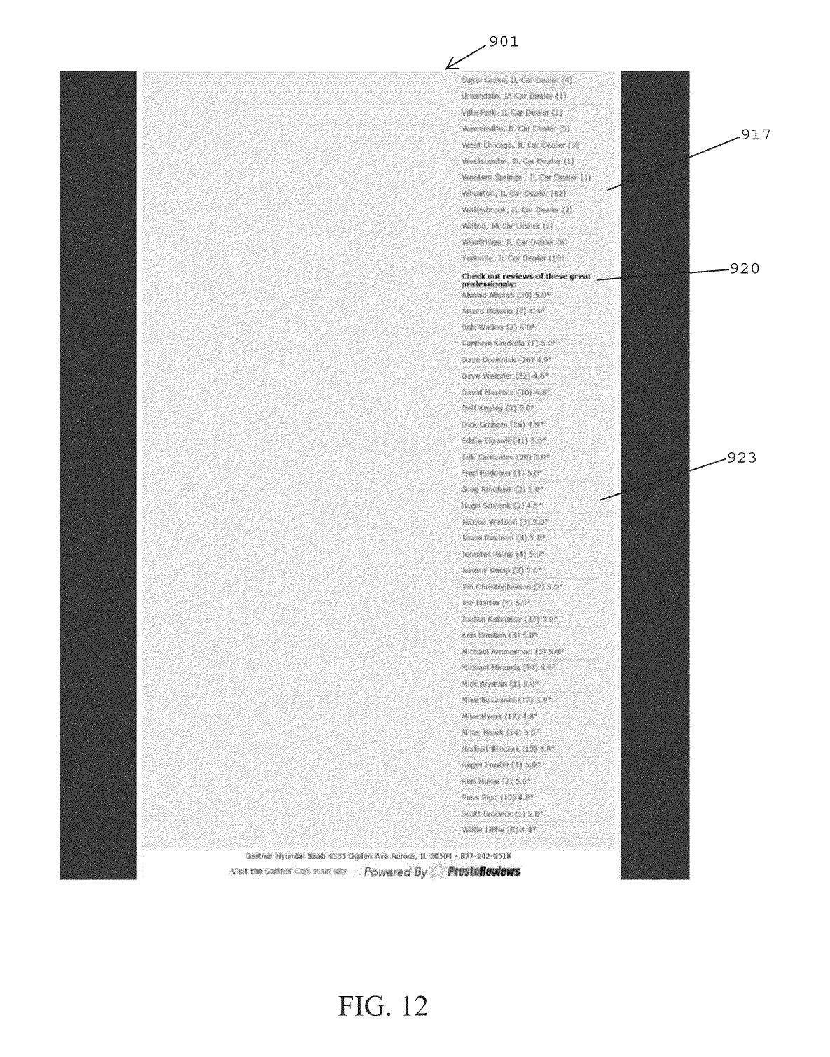

FIG. 12 is a screen shot of one embodiment of a display of an electronic data processing unit and shows a fourth page of a location specific screen shown in FIGS. 9-11. FIG. 12 shows a continuation of the list of electronic links 917 from FIG. 11 and a second list of electronic links 923 under the Salesperson Category 920 are displayed on a continuation of the electronic display location specific screen 901. Each of the electronic links in the second list of electronic links 923 identifies a group of grouped and aggregated consumer reviews that have been written about the specific salesperson designated in the electronic link. Selecting one of the electronic links in the list of electronic links 923 will display a network location containing a group of grouped and aggregated consumer reviews specific to the salesperson selected.

FIG. 13 is a screen shot of one embodiment of a display of an electronic data processing unit and shows a first page of the salesperson specific screen. As shown in FIG. 13, the electronic display salesperson specific screen 1301 is preferably comprised of a leaderboard 1302, a title 1304, consumer reviews 1307 and 1308, an entity response 1312 to consumer review 1307, a write a review option 1315, and various advertisements and other links 1318 and 1319. The leaderboard 1302 displays the name of the entity that is being reviewed. Although FIG. 13 displays “Gartner Hyundai Customer Reviews,” “Gartner Hyundai” is intended only to be an example of the contents of the leaderboard 1302, and will be changed on each network location to identify the specific entity being reviewed. The title 1304 displays the name of the salesperson about whom the consumer reviews have been written and are displayed. Because the displayed consumer reviews 1307 and 1308 have been written about Arturo Moreno, the title 1304 reflects this: “Reviews of Arturo Moreno.” If the consumer wishes to submit a new consumer review, the consumer would select the write a review option 1315. Selecting the write a review option 1315 will display the electronic review form, as shown in FIG. 1. After submission of the new consumer review, it will be grouped and aggregated (as shown in FIG. 20). If the review has been written about salesperson Arturo Moreno, then this additional review would later be displayed on the electronic display salesperson specific screen 1301, along with the displayed consumer reviews 1307 and 1308. The various advertisements and other links 1318 and 1319 shown in FIG. 13 are intended to be representative of potential advertisements and other links that may be displayed on the electronic display salesperson specific screen 1301, and may be different depending upon the specific network location and the location of the consumer viewing the specific network location.

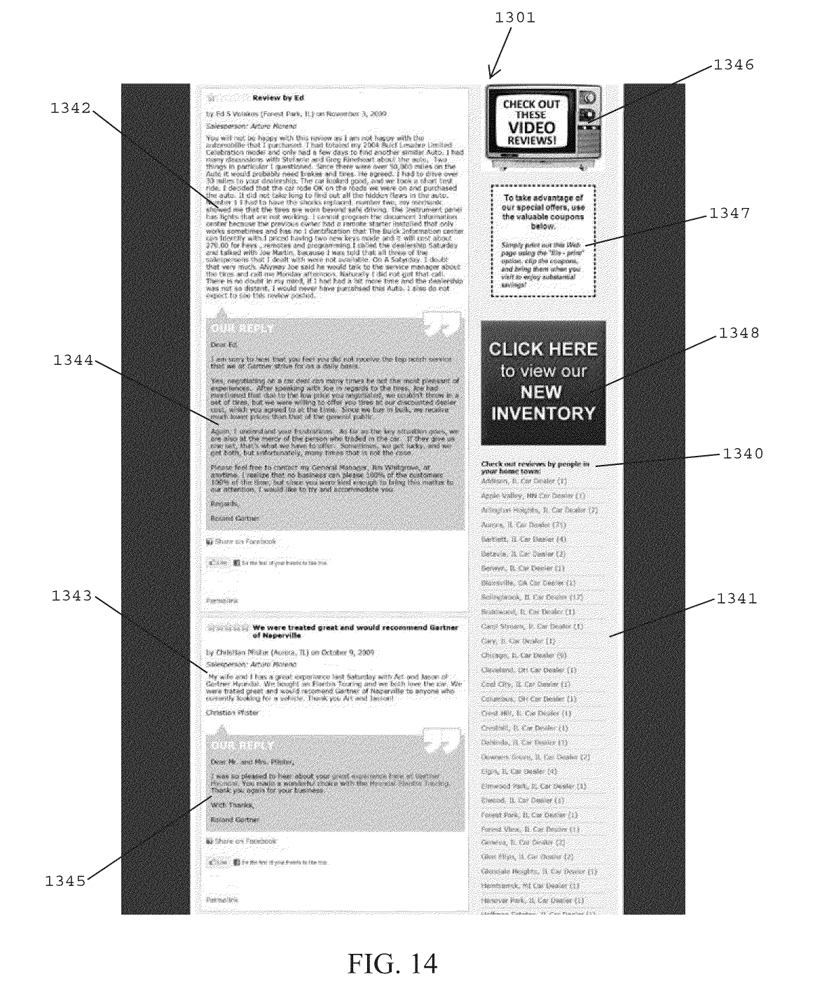

FIG. 14 is a screen shot of one embodiment of a display of an electronic data processing unit and shows a second page of the salesperson specific screen shown in FIG. 13. As shown in FIG. 14, the electronic display salesperson specific screen 1301 is further comprised of additional consumer reviews 1342 and 1343, entity responses 1344 and 1345, various advertisements 1346, 1347, and 1348, and a list of electronic links 1341 listed under a Location Category 1340. Similar to the consumer reviews in FIG. 13, the consumer reviews 1342 and 1343 are specifically pertaining to a particular salesperson of a given entity, and each may be accompanied by a respective entity response 1344 and 1345. The various advertisements and other links 1346, 1347, and 1348 are intended to be representative of potential advertisements and other links that may be displayed on the electronic display salesperson specific screen 1301, and may be changed depending upon the specific network location of the given entity or the location of the consumers viewing the network location. Each of the electronic links in the list of electronic links 1341 is an electronic link to a group of grouped and aggregated consumer reviews that have been submitted by consumers living in each of the specified locations on the face or title of each of the electronic links in the list of electronic links 1341.

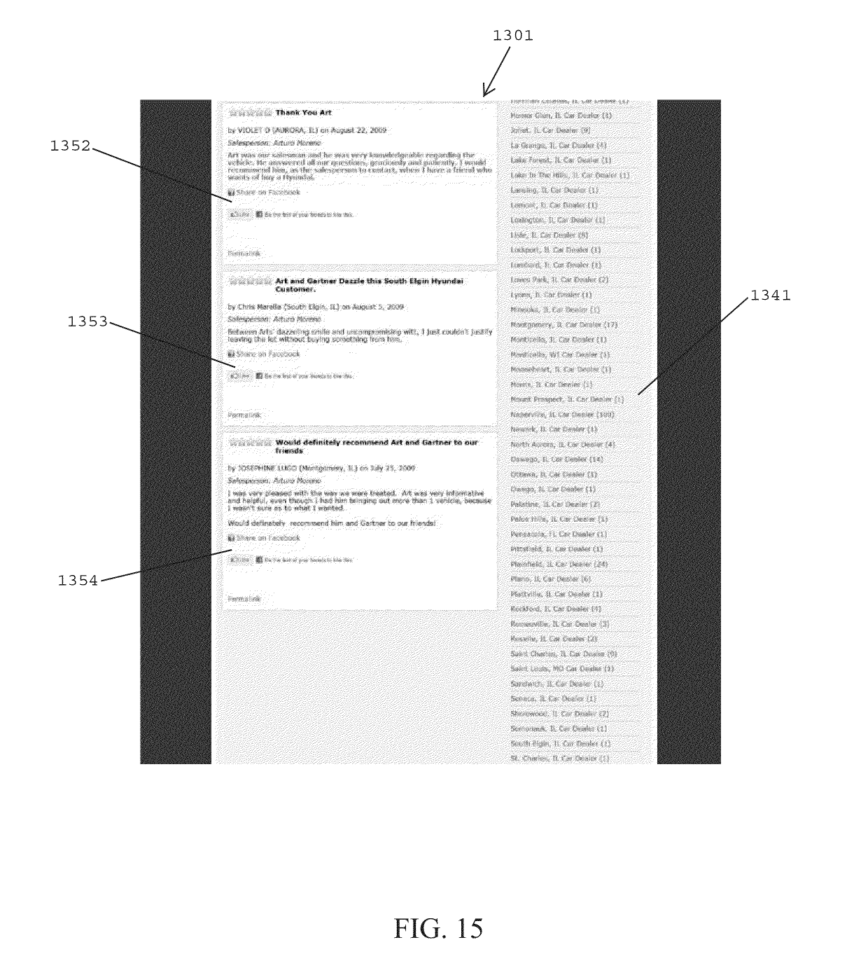

FIG. 15 is a screen shot of one embodiment of a display of an electronic data processing unit and shows a third page of the salesperson specific screen shown in FIGS. 13-14. FIG. 15 shows that the electronic display salesperson specific screen 1301 may be further comprised of additional consumer reviews 1352, 1353, and 1354, and a continuation of the list of electronic links 1341 from FIG. 14. Each of the consumer reviews 1352, 1353, and 1354 has been written about the particular salesperson within the entity being reviewed, whose name is displayed in the title 1304, as shown in FIG. 13. The list of electronic links 1341 is comprised of electronic links that each pertain to a group of grouped and aggregated consumer reviews of the given entity that have been submitted by consumers who live in the particular location indicated by the electronic link.

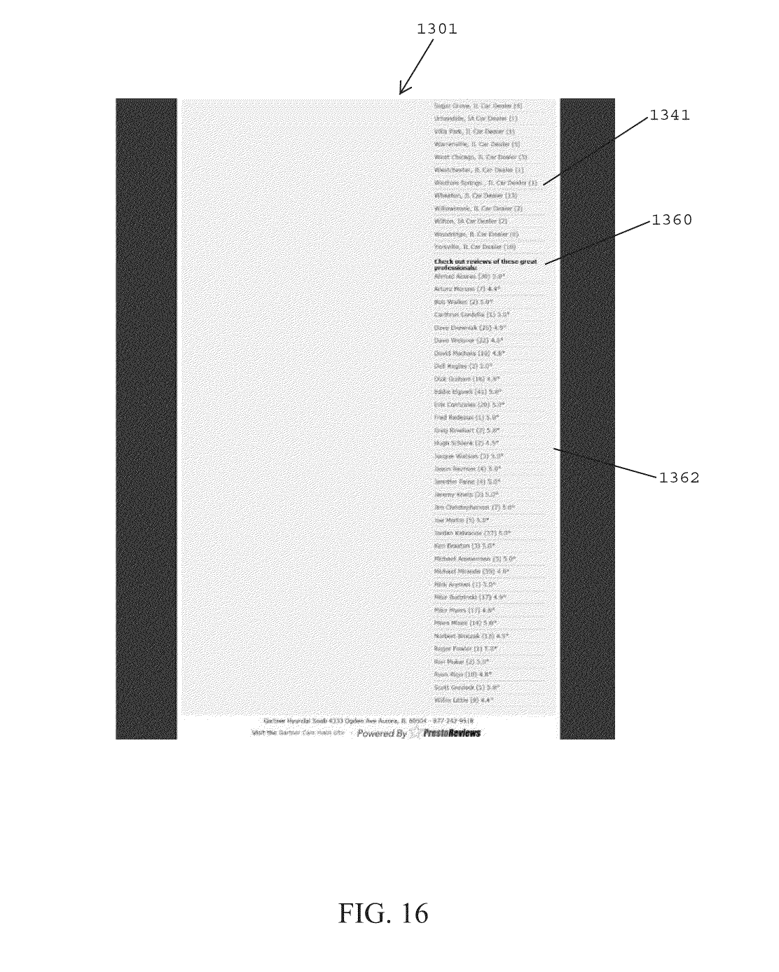

FIG. 16 is a screen shot of one embodiment of a display of an electronic data processing unit and shows a fourth page of the salesperson specific screen shown in FIGS. 13-15. FIG. 16 shows that the electronic display salesperson specific screen 1301 is preferably further comprised of a continuation of the list of electronic links 1341 from FIG. 15, and a second list of electronic links 1362 under a Salesperson Category 1360. Each of the electronic links in the second list of electronic links 1362 is an electronic link to a group of grouped and aggregated reviews specific to the particular salesperson specified in the electronic link.

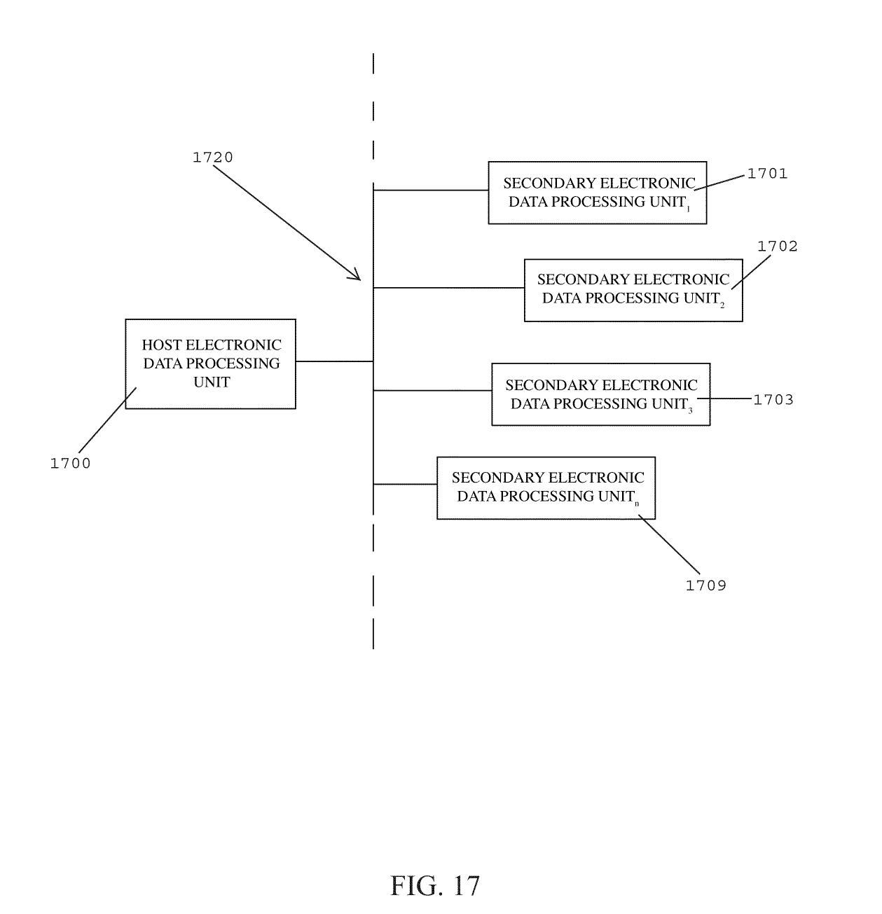

FIG. 17 is flow chart of one embodiment of the networked plurality of electronic data processing units. The aggregation, grouping, and displaying of the consumer reviews cannot occur without a plurality of electronic data processing units. Within that plurality of electronic data processing units, there is at least one host electronic data processing unit 1700. The host electronic data processing unit is comprised of a database and the host electronic data processing unit performs all of the processing, aggregating, and grouping of the consumer reviews that are stored or sent to that database. The host electronic data processing unit 1700 is connected to a plurality of secondary electronic data processing units 1701, 1702, 1703, and 1709 through a network 1720, such as an intranet or internet that provides a connection so that the grouped and aggregated consumer reviews may be displayed on the displays of the plurality of secondary electronic data processing units 1701, 1702, 1703, and 1709. Although FIG. 17 shows that there are four secondary electronic data processing units 1701, 1702, 1703, and 1709, it is anticipated that there may be any number of secondary electronic data processing units.

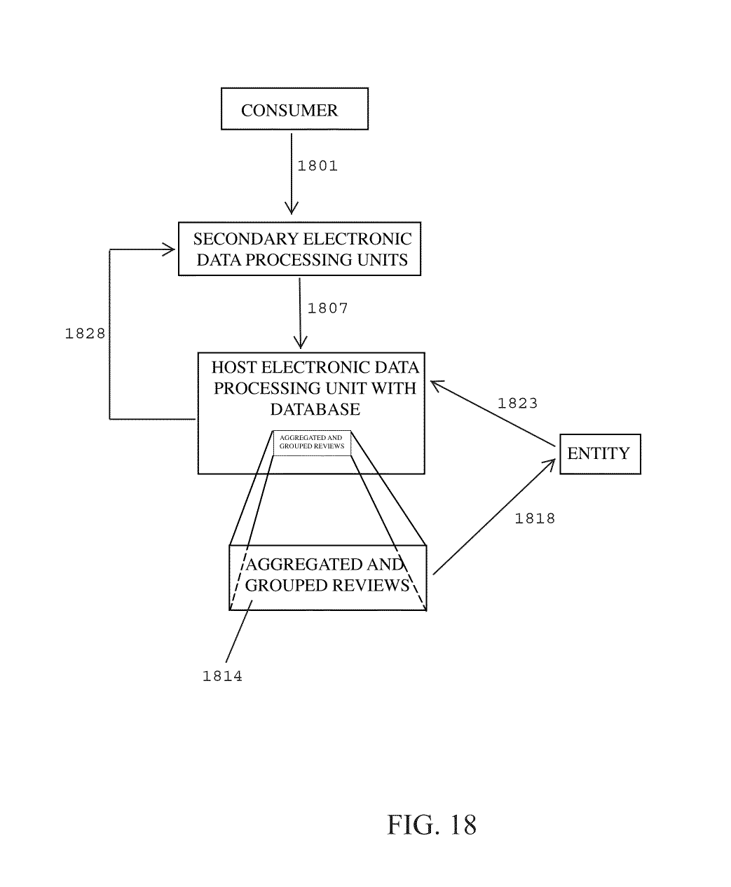

FIG. 18 is a flowchart of one embodiment of the invention. FIG. 18 is an illustration of a flowchart to explain the method of generating, aggregating, grouping, storing, moderating, and displaying the consumer reviews, and the relationship of the reviewing consumer and the entity being reviewed. At step 1801, a consumer uses one secondary electronic data processing unit, from a plurality of secondary electronic data processing units, to enter electronic review data into the electronic review form shown in FIG. 1. At step 1807, the completed electronic review form is uploaded to the host electronic data processing unit. The host electronic data processing unit will then process, aggregate, and group the uploaded consumer reviews at step 1814. At step 1818, the processed, aggregated, and grouped consumer reviews are then moderated, reviewed, and or edited, by the entity being reviewed, to correct any errors in the consumer reviews and to add an entity response to each of the consumer reviews, if desired. The moderated reviews, along with the entity responses to the consumer reviews, are uploaded to the host electronic data processing unit at step 1823. The moderated reviews are then displayed on the secondary electronic processing units at step 1828 as the reviews are searched for by new consumers.

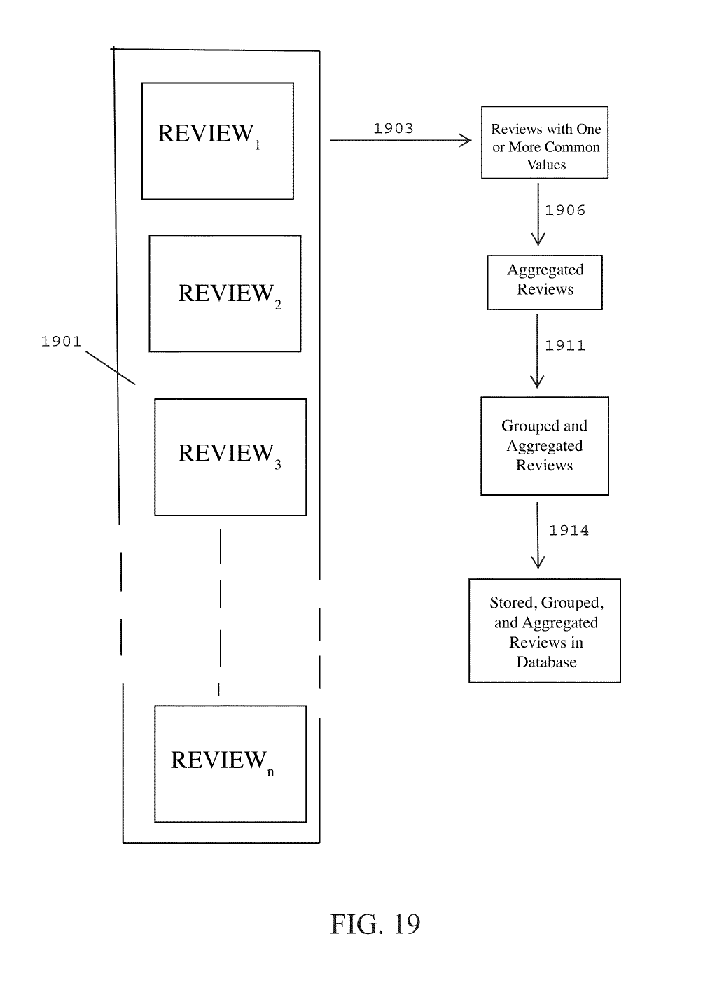

FIG. 19 is a flowchart of one embodiment of the invention and shows the aggregation process that is performed by the host electronic data processing unit. A plurality of consumer reviews 1901 are uploaded to the host electronic data processing unit. The host electronic data processing unit then, at step 1903, processes the plurality of consumer reviews to determine the presence of one or more common values within each of the uploaded consumer reviews of the plurality of consumer reviews 1901. After the consumer reviews have been processed, the host electronic data processing unit uses the common values to aggregate the reviews together at step 1906. These aggregated reviews are then grouped by the host electronic data processing unit at step 1911. Finally, the grouped and aggregated reviews are stored in the database of the host electronic data processing unit at step 1914.

FIG. 20 is a flowchart of one embodiment of the method of associating, grouping, aggregating, storing, moderating, and displaying consumer reviews. As shown in FIG. 20, the reviewing consumers create consumer reviews using secondary electronic data processing units from a plurality of secondary electronic data processing units at step 2000. The created consumer reviews are uploaded to an electronic database 2020 of the host electronic processing unit at step 2001. Additionally, search terms are selected by the entity being reviewed and entered into the host electronic data processing unit at step 2002. Common values among the uploaded consumer review and previously uploaded consumer reviews are determined or looked for by the host electronic data processing unit at step 2003. Next, the common values in the consumer reviews are associated with the search terms that had been selected by the entity being reviewed by the host electronic data processing unit at step 2004. The consumer reviews are then aggregated based on the common values by the host electronic processing unit at step 2005. The aggregated consumer reviews are then grouped by the host electronic data processing unit at step 2006. The grouped and aggregated reviews are then stored in the electronic database 2020 at step 2007. The entity then retrieves the stored consumer reviews from the electronic database 2020 of the host electronic data processing unit and moderates these consumer reviews, correcting any errors and adding a response to these reviews, at step 2008. The moderated reviews, as aggregated and grouped, are then stored in the electronic database 2020 of the host electronic data processing unit at step 2009. Although the reviews may be accessible before moderation, preferably only moderated reviews are accessible. The reviews may be first moderated and then grouped and aggregated without deviating from the scope of the invention. Each review may very well be grouped or aggregated into at least two groups, one based on location and the other on the salesperson. Other embodiments of the invention might include other groups such as sub-location groupings. The entire process of associating (with key search terms), aggregating, and grouping the consumer reviews leads to the grouped and aggregated consumer reviews, and their associated network locations, to be highly ranked on search engine results pages, as shown in steps 2010, 2011. The reviews may be retrieved by new consumers using one of the plurality of secondary electronic data processing units. New consumers easily find the reviews because the network locations of the associated, grouped, and aggregated reviews are highly ranked on search engine results pages, as shown in steps 2010, 2011. For example, step 2010 shows that a user searches for the entity's business type (such as a car dealership) and a location. If the business type and location are two of the search terms that are associated with the grouped and aggregated reviews, that group of reviews would be highly ranked on the search engine results page for the entity, as shown in step 2011. If the new consumer then buys the product and wishes to write a review, as shown in step 2012, the method would preferably begin again at step 2000, with the new consumer creating a consumer review using a secondary electronic data processing unit from the plurality of secondary electronic data processing units.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method of aggregating consumer reviews comprising the steps of:
providing an entity to be reviewed by a plurality of consumers of said entity;
providing at least one host electronic data processing unit;
wherein said at least one host electronic data processing unit is comprised of an electronic database;
providing a plurality of secondary electronic data processing units;
wherein said at least one host electronic data processing unit is networked with said plurality of secondary electronic data processing units;
entering a plurality of consumer reviews of said entity by said plurality of consumers using said plurality of secondary electronic data processing units;
uploading said plurality of consumer reviews to said electronic database;
selecting by said entity one or more search terms to be associated with one or more common values;
processing said plurality of uploaded consumer reviews by said at least one host electronic data processing unit to determine a presence of said one or more common values within an entirety of said plurality of uploaded consumer reviews;
associating by said at least one host electronic data processing unit said one or more search terms with each common value of said one or more common values;
wherein said one or more common values are subsets of one or more categories;
aggregating said plurality of consumer reviews by said at least one host electronic data processing unit based on said one or more common values;
grouping said aggregated plurality of consumer reviews based on at least one of said one or more common values;
storing said grouped and aggregated plurality of consumer reviews in said electronic database;
wherein said grouped and aggregated plurality of consumer reviews are accessible to said plurality of consumers as grouped and aggregated;
retrieving at least one group of said grouped and aggregated plurality of consumer reviews from said electronic database; and
displaying said retrieved at least one group of said grouped and aggregated plurality of consumer reviews.

2. The computer-based method of aggregating consumer reviews of claim 1, further comprising the steps of:
associating each group of said grouped and aggregated plurality of consumer reviews with a network location.

3. The computer-based method of aggregating consumer reviews of claim 2, further comprising the steps of:
wherein each of said plurality of consumer reviews is aggregated and associated with at least two groups of said grouped and aggregated plurality of consumer reviews.

4. The computer-based method of aggregating consumer reviews of claim 3, further comprising the steps of:
moderating by said entity said plurality of consumer reviews before said plurality of consumer reviews are made accessible to said plurality of consumers.

5. The computer-based method of aggregating consumer reviews of claim 4, further comprising the steps of:
wherein said network location of each associated, grouped, and aggregated plurality of consumer reviews is optimized for a plurality of search engine rankings based on said step of associating by said at least one host electronic data processing unit said one or more search terms with each common value of said one or more common values.

6. The computer-based method of aggregating consumer reviews of claim 5, further comprising the steps of:
generating by said at least one host electronic data processing unit a first electronic display;
wherein said plurality of secondary electronic data processing units are comprised of one or more displays;
displaying said first electronic display on said one or more displays of said plurality of secondary electronic data processing units; and
wherein said first electronic display is comprised of at least one consumer review of said plurality of consumer reviews and at least one electronic link to at least one of said plurality of network locations associated with said grouped and aggregated plurality of consumer reviews.

7. The computer-based method of aggregating consumer reviews of claim 6, further comprising the steps of:
wherein said first electronic display is further comprised of an electronic write a review link.

8. The computer-based method of aggregating consumer reviews of claim 7, further comprising the steps of:
generating by said at least one host electronic data processing unit a second electronic display;
displaying said second electronic display on said one or more displays of said plurality of secondary electronic data processing units; and
wherein said second electronic display is comprised of all consumer reviews of at least one group of said grouped and aggregated plurality of consumer reviews from said electronic database, a plurality of electronic links to said plurality of network locations associated with said grouped and aggregated plurality of consumer reviews, and an electronic write a review link.

9. The computer-based method of aggregating consumer reviews of claim 8, further comprising the steps of:
selecting by a reviewing consumer said electronic write a review link;
displaying on said one or more displays of said plurality of secondary electronic data processing units by said at least one host electronic data processing unit an electronic review form; and
wherein said electronic review form is comprised of a plurality of review data fields.

10. The computer-based method of aggregating consumer reviews of claim 9, further comprising the steps of:
wherein said plurality of review data fields are comprised of a location data field;
wherein said location data field is a location of said reviewing consumer; and
entering by said reviewing consumer said location of said reviewing consumer into said location data field to create a plurality of completed electronic review forms.

11. The computer-based method of aggregating consumer reviews of claim 9, further comprising the steps of:
wherein said plurality of review data fields are comprised of: a location data field and a salesperson data field;
wherein said location data field is a location of said reviewing consumer, and said salesperson data field is a salesperson of said entity being reviewed; and
entering by said reviewing consumer said location of said reviewing consumer into said location data field and said name of said salesperson of said entity being reviewed into said salesperson data field.

12. The computer-based method of aggregating consumer reviews of claim 9, further comprising the steps of:
wherein said plurality of review data fields are comprised of: a First Name data field;
a Last Name data field; a Location data field; an E-Mail Address data field; a Rating data field; a Salesperson data field; and a Review data field;
entering by said reviewing consumer a plurality of consumer review data into said plurality of review data fields;
wherein said plurality of consumer review data are said one or more common values; and
wherein said plurality of review data fields are said one or more categories.

13. The computer-based method of aggregating consumer reviews of claim 9, further comprising the steps of:
wherein said categories are comprised of a location category, and a salesperson category; and
wherein said location category is a location of said reviewing consumer, and said salesperson category is a salesperson of said entity being reviewed.

14. The computer-based method of aggregating consumer reviews of claim 10, further comprising the steps of:
wherein said step of moderating by said entity comprises the steps of:
retrieving by said at least one host electronic data processing unit one of said plurality of completed electronic review forms;
wherein said plurality of completed electronic review forms are comprised of: a Consumer Review data field; and an Entity Response data field;
correcting by said entity a plurality of errors in said Consumer Review data field committed by said reviewing consumer to create a corrected consumer review data; and
entering by said entity a plurality of entity response data into said Entity Response data field.

15. The computer-based method of aggregating consumer reviews of claim 14, further comprising the steps of:
wherein said step of moderating by said entity further comprises the steps of:
wherein said plurality of completed electronic review forms are further comprised of:
a drop down menu with at least an Approved option;
approving by said entity said corrected consumer review data and said entered entity response data, such that a plurality of moderated consumer reviews and entity responses are created; and
uploading said plurality of moderated consumer reviews and entity responses to said electronic database.

16. A computer-based method of aggregating consumer reviews comprising the steps of:
providing an entity to be reviewed by a plurality of consumers of said entity;
providing at least one host electronic data processing unit;
wherein said at least one host electronic data processing unit is comprised of an electronic database;
providing a plurality of secondary electronic data processing units;
wherein said plurality of secondary electronic data processing units is comprised of a display;
wherein said at least one host electronic data processing unit is networked with said plurality of secondary electronic data processing units;
entering a plurality of consumer reviews of said entity by said plurality of consumers using said plurality of secondary electronic data processing units;
uploading said plurality of consumer reviews to said electronic database;
selecting by said entity one or more search terms to be associated with one or more common values;
processing said plurality of uploaded consumer reviews by said at least one host electronic data processing unit to determine a presence of said one or more common values within an entirety of said plurality of uploaded consumer reviews;
associating by said at least one host electronic data processing unit said one or more search terms with each common value of said one or more common values;
wherein said one or more common values are subsets of one or more categories;
aggregating said plurality of consumer reviews by said at least one host electronic data processing unit based on said one or more common values;
grouping said aggregated plurality of consumer reviews based on at least one of said one or more common values;
storing said grouped and aggregated plurality of consumer reviews in said electronic database;
wherein said grouped and aggregated plurality of consumer reviews are accessible to said plurality of consumers as grouped and aggregated;
retrieving at least one group of said grouped and aggregated plurality of consumer reviews from said electronic database;
displaying said retrieved at least one group of said grouped and aggregated plurality of consumer reviews;
associating each group of said grouped and aggregated plurality of consumer reviews with a network location;
wherein each of said plurality of consumer reviews is aggregated and associated with at least two groups of said grouped and aggregated plurality of consumer reviews;
moderating by said entity said plurality of consumer reviews before said plurality of consumer reviews are made accessible to said plurality of consumers;
wherein said network location of each associated, grouped, and aggregated plurality of consumer reviews is optimized for a plurality of search engine rankings based on said step of associating by said at least one host electronic data processing unit said one or more search terms with each common value of said one or more common values;
generating by said at least one host electronic data processing unit a first electronic display;
wherein said plurality of secondary electronic data processing units are comprised of one or more displays;
displaying said first electronic display on said one or more displays of said plurality of secondary electronic data processing units;
wherein said first electronic display is comprised of at least one consumer review of said plurality of consumer reviews and at least one electronic link to at least one of said plurality of network locations associated with said grouped and aggregated plurality of consumer reviews; and an electronic write a review link;
generating by said at least one host electronic data processing unit a second electronic display;
displaying said second electronic display on said one or more displays of said plurality of secondary electronic data processing units;
wherein said second electronic display is comprised of all consumer reviews of at least one group of said grouped and aggregated plurality of consumer reviews from said electronic database, a plurality of electronic links to said plurality of network locations associated with said grouped and aggregated plurality of consumer reviews, and an electronic write a review link;
selecting by a reviewing consumer said electronic write a review link;
displaying on said one or more displays of said plurality of secondary electronic data processing units by said at least one host electronic data processing unit an electronic review form;
wherein said electronic review form is comprised of a plurality of review data fields;
wherein said plurality of review data fields are comprised of: a First Name data field; a Last Name data field; a Location data field; an E-Mail Address data field; a Rating data field; a Salesperson data field; and a Review data field;
entering by said reviewing consumer a plurality of consumer review data into said plurality of review data fields to create a plurality of completed electronic review forms;
wherein said plurality of consumer review data are said one or more common values;
wherein said plurality of review data fields are said one or more categories;
wherein said categories are comprised of a location category, and a salesperson category;
wherein said location category is a location of said reviewing consumer, and said salesperson category is a salesperson of said entity being reviewed;
wherein said step of moderating by said entity comprises the steps of:
retrieving by said at least one host electronic data processing unit one of said plurality of completed electronic review forms;
wherein said plurality of completed electronic review forms are comprised of: a Consumer Review data field; an Entity Response data field; and a drop down menu with at least an Approved option;
correcting by said entity a plurality of errors in said Consumer Review data field committed by said reviewing consumer to create a corrected consumer review data;
entering by said entity a plurality of entity response data into said Entity Response data field;
approving by said entity said corrected consumer review data and said entered entity response data, such that a plurality of moderated consumer reviews and entity responses are created; and
uploading said plurality of moderated consumer reviews and entity responses to said electronic database.

17. A computer-based method of aggregating consumer reviews comprising the steps of:
providing an entity to be reviewed by a plurality of consumers of said entity;
providing at least one host electronic data processing unit;
wherein said at least one host electronic data processing unit is comprised of an electronic database;
providing a plurality of secondary electronic data processing units;
wherein said plurality of secondary electronic data processing units is comprised of a display;
wherein said at least one host electronic data processing unit is networked with said plurality of secondary electronic data processing units;
entering a plurality of consumer reviews of said entity by said plurality of consumers using said plurality of secondary electronic data processing units;
uploading said plurality of consumer reviews to said electronic database;
selecting by said entity one or more search terms to be associated with one or more common values;
processing said plurality of uploaded consumer reviews by said at least one host electronic data processing unit to determine a presence of said one or more common values within an entirety of said plurality of uploaded consumer reviews;
associating by said at least one host electronic data processing unit said one or more search terms with each common value of said one or more common values;
wherein said one or more common values are subsets of one or more categories;
aggregating said plurality of consumer reviews by said at least one host electronic data processing unit based on said one or more common values;
grouping said aggregated plurality of consumer reviews based on at least one of said one or more common values;
storing said grouped and aggregated plurality of consumer reviews in said electronic database; and
wherein said grouped and aggregated plurality of consumer reviews are accessible to said plurality of consumers as grouped and aggregated.

18. The computer-based method of aggregating consumer reviews of claim 17, further comprising the steps of:
retrieving at least one group of said grouped and aggregated plurality of consumer reviews from said electronic database;
generating by said at least one host electronic data processing unit an electronic display;
displaying said electronic display on said one or more displays of said plurality of secondary electronic data processing units; and
wherein said electronic display is comprised of all consumer reviews of said at least one group of said grouped and aggregated plurality of consumer reviews from said electronic data, a plurality of electronic links to a plurality of network locations associated with said grouped and aggregated plurality of consumer reviews, and an electronic write a review link.

19. The computer-based method of aggregating consumer reviews of claim 18, further comprising the steps of:
selecting by a reviewing consumer said electronic write a review link;
displaying on said one or more displays of said plurality of secondary electronic data processing units by said at least one host electronic data processing unit an electronic review form;
wherein said electronic review form is comprised of a plurality of review data fields;
wherein said plurality of review data fields are comprised of a location data field;
wherein said location data field is a location of said reviewing consumer;
entering by reviewing consumer said location of said reviewing consumer into said location data field to create a plurality of completed electronic review forms;
wherein said location of said reviewing consumer is one of said one or more common values; and
wherein said location data field is one of said one or more categories.

20. The computer-based method of aggregating consumer reviews of claim 19, further comprising the steps of:
associating each group of said grouped and aggregated plurality of consumer reviews with a network location; and
wherein said network location of each associated, grouped, and aggregated plurality of consumer reviews is optimized for a plurality of search engine rankings based on said step of associating by said at least one host electronic data processing unit said one or more search terms with each common value of said one or more common values.
